(19) United States
(12) Patent Application Publication
(10) Pub. No.: US 2007/0263044 A1
(43) Pub. Date: Nov. 15, 2007

(54) Chip retaining device of ink cartridge used in ink-jet printer

(76) Inventor: Shui Kuen NIP, Hong Kong (HK)

Correspondence Address: RABIN & Berdo, PC, 1101 14TH STREET, NW, SUITE 500, WASHINGTON, DC, 20005, US

(21) Appl. No.: 11/745,115

(22) Filed: May 7, 2007

(30) Foreign Application Priority Data
May 9, 2006 (CN) 200620058646.6

(51) Int. Cl. B41J 2/17

(52) U.S. Cl. 347/84; 347/86

(57) ABSTRACT

The present invention relates to a chip retaining device for connecting a chip (9) to an ink cartridge (1). The device includes a chip holder for holding a chip (9) and a fitting structure which cooperates with the chip holder and is located on an external surface of ink cartridge (1). The fitting structure has at least one sliding groove and at least one limiting rib (2). The chip holder further comprises at least one sliding member (8) capable of being slidably received within the at least one sliding groove and at least one engagement tab (7) for engaging with the at least one limiting rib (2) when the chip holder is installed to the fitting structure and to releasably secure the chip holder within the fitting structure. After the ink cartridge (1) is depleted of ink, the chip holder may be removed so that the chip (9) and the ink cartridge can be separately recycled and the chip can be reset for reuse.

### CROSS-REFERENCE TO RELATED APPLICATION

This non-provisional application claims priority under 35 U.S.C. §119(a) on Patent Application No. 200620058646.6 filed in China on May 9, 2006, the entire contents of which are hereby incorporated by reference.

### FIELD OF THE INVENTION

The present invention relates to a chip retaining device. More particularly, although not exclusively, the present invention relates to the method of chip installation, chip retention and chip recovery of an ink cartridge for use in an ink-jet printer.

### BACKGROUND OF THE INVENTION

Traditional ink-jet printers use ink cartridges having chips (circuit boards) which are fixed directly onto the ink cartridges through non-removable connection means, such as by heat-staking, welding or adhesive gluing. At the end of the usable life of such an ink cartridge, the chip would be disposed of along with its ink cartridge. It is difficult to recycle the chip separately from the rest of the ink cartridge housing and this results not only in large amount of electronic waste which causes increased environmental pollution problems and costs, but also prevents the chip from being reset and reused therefore causing unnecessary cost and waste.

In light of these problems, ink cartridges with removable chips are already available in the market. However, the chips are installed to a corresponding connection device provided on the ink cartridge through simple methods of interference fit which, due to imperfect construction, are unreliable. For example, if the interference fit is not tight enough then the installed chip is easily dislodged and when the interference fit is too tight then the installation and removal of the chip becomes very difficult and causes problems and inconvenience during the manufacturing assembly process and to the end users. In addition, due to the large size of the interference fit construction, the design is not suitable to be used in many other smaller ink cartridges. Also, due to the lack of any chip installation orientation indication, the chip is often installed in a wrong orientation causing the ink cartridge inoperable.

### SUMMARY OF THE INVENTION

It is therefore the object of the present invention to improve the connection method of the chip to the ink cartridge by providing a chip retaining device on the ink cartridge to make the chip installation and removal more reliable, more convenient and safer.

Another object of the present invention is to allow a user to remove, reset and reuse the chip after the usable life of the ink cartridge, to reduce cost of use as well as to reduce the amount of electronic waste.

The above-mentioned objects of the present invention are realized by a chip retaining device for connecting a chip to an ink cartridge. The device includes a chip holder for holding a chip and a fitting structure which cooperates with the chip holder and is located on an external surface of ink cartridge. The fitting structure has at least one sliding groove and at least one limiting rib. The chip holder further comprises at least one sliding member capable of being slidably received within the at least one sliding groove and at least one engagement tab for engaging with the at least one limiting rib when the chip holder is installed to the fitting structure and to releasably secure the chip holder within the fitting structure. The at least one sliding member and the at least one engagement tab are preferably formed on a rear surface of the chip holder (i.e. the surface that faces towards the ink cartridge when the chip holder is secured to the ink cartridge).

The chip holder preferably further includes a protection frame and at least one location post for securing the chip within the chip holder. The at least one location post may have a L-shaped undercut at its tip or may be a press fit with at least one opening (slot) formed in the chip. The at least one location post can be grooved in an axial direction to improve its elasticity.

L-shaped undercuts can also be formed on a pair edges of the protection frame to secure the chip within the chip holder.

The chip holder may further include one or both of a location chamfer and a direction mark for identifying an installation orientation of the chip holder relative to the ink cartridge.

The at least one groove and the at least one sliding member can have a dovetailed or any other suitable cross-section.

To install the chip to the ink cartridge, the chip is first releasably secured to the chip holder by use of the L-shaped undercuts in the tips of the location posts or the L-shaped undercuts provided in the edges of the protection frame. The chip holder is then removably secured to the ink cartridge by slidably inserting the sliding member into the sliding groove of the fitting structure. Stopping engagement between the at least one engagement tab and the at least one limiting rib serves to retain the chip holder within the fitting structure until it is deliberately removed by a user.

The chip retaining device has precise locations for installation and reliably secured connections. This means that the detection and recognition of the ink cartridge by the printer is not affected and the possibility of accidental separation of the chip from the ink cartridge can be avoided.

### BRIEF DESCRIPTION OF THE DRAWINGS

Detailed structure of the present invention are shown in the following embodiments and drawings:

FIG. 1 is a front view of the chip retaining device with the chip assembled to the ink cartridge;

FIG. 2 is a cross-sectional view taken in the direction A-A in FIG. 1;

FIG. 3 is a cross-sectional view taken in the direction B-B in FIG. 1;

FIG. 4 is a cross-sectional view taken in the direction C-C in FIG. 1;

FIG. 5 is a front view of an alternative chip frame having L-shaped undercuts for retaining the chip within frame; and

FIG. 6 is a cross-sectional view taken in the direction D-D in FIG. 5.

In these figures, the labels and their corresponding part names are:

“1” ink cartridge,

“2” limiting rib,

“3” direction mark,

“4” location chamfer,

“5” location post,

“6” protection frame,

“6a” L-shaped undercut,

“7” engagement tab,

“8” sliding member,

“8a” opposing edges of sliding member,

“9” chip, and

“10” location edge of ink cartridge.

### DETAILED DESCRIPTION OF THE PREFERRED EMBODIMENTS

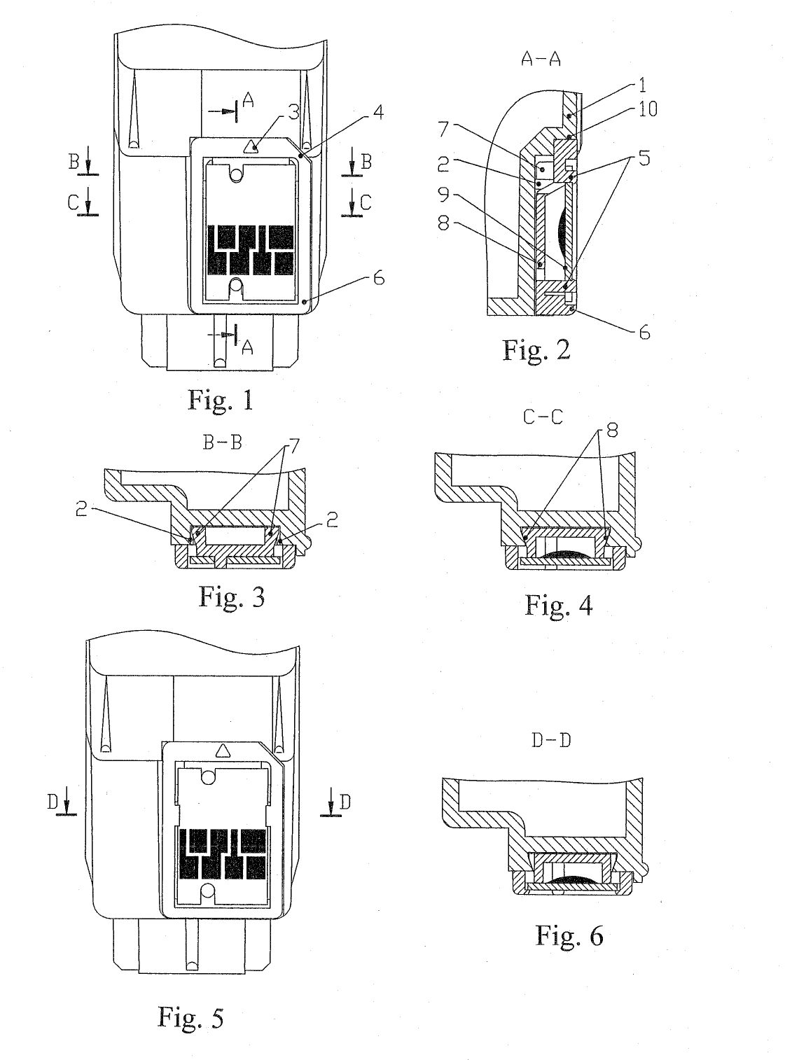

A chip retaining device for connecting a chip (circuit board) to an ink cartridge for an ink-jet printer will be described with reference to FIGS. 1 to 4. The chip retaining device includes a chip holder and a fitting structure which matches with the chip holder and is located on an external surface of the ink cartridge 1.

The fitting structure includes a sliding groove having opposing sliding channels and is located on an external surface of the ink cartridge 1. A pair of limiting ribs 2 is provided in the sliding groove. A chip installation location and protection structure includes a sliding member 8 having opposing edges 8a and two engagement tabs 7 provided on a rear surface of the chip holder. The distance between the two outside tab surfaces of the engagement tabs 7 is slightly larger than the distance between the two inner rib surfaces of the limiting ribs 2 in order to secure the chip holder to the ink cartridge 1. The chip installation location and protection structure further includes a protection frame 6 that surrounds the chip 9 and two location posts 5 which have an L-shaped undercut at their tips. The distance between two location posts 5 and the distance between the two location slots of the chip 9 are designed to create an interference fitting in order to locate and secure the chip within the chip holder. The L-shaped undercut at the tip of each location post can increase the reliability of the chip securement in the axial direction on the location post. The location posts 5 can be grooved in an axial direction in order to increase their elasticity so that the location slots of the chip 9 can be conveniently snapped into the L-shaped undercuts making chip installation much easier. The fitting between the two location posts 5 and the two corresponding location slots of the chip 9 can also be designed to create an interference fit.

The protection frame 6 is designed to provide a handling portion for the chip 9 in order to avoid direct contact between human hands and the chip and thus prevent electrostatic damage to the chip. Furthermore, as shown in FIGS. 5 and 6, an L-shaped undercut 6a can also be designed on a pair of opposing edges of the protection frame 6 (optionally at an intermediate location thereof) for securing the chip in an arrangement where the location posts 5 do not have L-shaped undercuts.

A location chamfer 4 and direction mark 3 are provided on the chip holder to identify the proper orientation of the chip holder so that it can correctly installed to the fitting structure provided on the external surface of the ink cartridge. A corresponding location chamber can be provided on a surface of the ink cartridge such that the respective chamfers are in visual register once the chip holder has been properly installed.

The chip 9 is to be installed into the chip holder before the chip holder is installed onto the ink cartridge 1. In the installation, the upper and lower location slots of the chip 9 are to be aligned with the upper and lower location posts 5 of the chip holder and a light force is to be applied on the chip. The location posts 5 have a certain elasticity due to their small diameters and the fact that they are moulded in elastic plastic material. This means that the chip 9 can be easily pressed down below the L-shaped undercuts in the tip of the location posts resulting in the chip being securely fixed to the chip holder by the L-shaped undercuts.

When the ink cartridge is required to be installed to the printer, the chip holder having the chip 9 already installed can be releasably secured to the ink cartridge in the correct orientation as indicated by the direction mark 3 and the location chamfer 4. More particularly, the chip holder is aligned with the sliding groove of the fitting structure on the ink cartridge 1 so that the sliding member 8 on the back of chip holder can be pushed upwardly into the sliding groove with the opposing edges 8a slidably received in the opposing channels of the sliding groove as shown in FIGS. 3 and 4. During this process, it will be readily appreciated that the chip holder can be easily and safely handled by the user by holding the sides of the protection frame 6 that surrounds and protects the chip 9. As shown in FIG. 3, the sliding groove and the corresponding sliding member 8 have a dovetailed cross-section such that the sliding member cannot be removed through the opening in the chip holder that is defined by the edges of the sliding groove. However, other cross-sections can be used.

After the top side surface of the frame 6 of the chip holder is in contact with a location edge 10 of the ink cartridge 1, the chip holder installation has been correctly completed. At this time, the engagement tabs 7 on the rear side of the chip holder are positioned in the opposing sliding channels of the sliding groove between the limiting ribs 2 and the location edge 10 of the ink cartridge. As mentioned above, the distance between the outer surfaces of the two engagement tabs 7 is larger than the distance between the inner surfaces of the two limiting ribs 2 of the fitting structure of the ink cartridge. However, the elastic properties of the engagement tabs 7 means that they can be deflected inwardly past the limiting ribs 2 as the chip holder is pushed into the sliding groove 8. Once the chip holder is properly located in the fitting structure, the engagement tabs 7 lie above the limiting ribs 2 and prevent the chip holder from being accidentally dislodged from the sliding groove of the ink cartridge. In addition, because the edge of the frame 6 surrounding the chip and the engagement tabs 7 of the chip holder are in contact respectively and simultaneously with the location edge 10 of the ink cartridge and the limiting ribs 2, the chip holder cannot freely move up and down within the sliding grooves of the ink cartridge.

After the ink cartridge is finished, the engagement tabs 7 can be deflected past the limiting ribs 2 of the fitting structure by applying a light force to push the chip holder out of the sliding groove 8. Once the chip holder has been removed the chip 9 and the ink cartridge can be separately recycled. In this way, the environmental protection requirements of recycling and disposal of waste by categories can be conveniently realised. Moreover, if the chip is of a re-settable type then it can be conveniently reset and re-installed to a new ink cartridge for reuse, thereby extending the useable life of the chip.

What is claimed is:

1. A chip retaining device for connecting a chip (9) to an ink cartridge (1), comprising:
a chip holder for holding a chip (9); and
a fitting structure which cooperates with the chip holder and is located on an external surface of ink cartridge (1), the fitting structure having at least one sliding groove and at least one limiting rib (2);
wherein the chip holder further comprises at least one sliding member (8) capable of being slidably received within the at least one sliding groove and at least one engagement tab (7) for engaging with the at least one limiting rib (2) when the chip holder is installed to the fitting structure and to releasably secure the chip holder within the fitting structure.

2. A chip retaining device according to claim 1, wherein the chip holder further comprises a protection frame (6) and at least one location post (5) for securing the chip (9) within the chip holder.

3. A chip retaining device according to claim 2, wherein the at least one location post (5) has an L-shaped undercut at its tip.

4. A chip retaining device according to claim 2, wherein the at least one location post (5) is grooved in an axial direction.

5. A chip retaining device according to claim 2, wherein each location post (5) is received in an opening provided in the chip (9).

6. A chip retaining device according to claim 2, further comprising L-shaped undercuts on a pair edges of the protection frame (6).

7. A chip retaining device according to claim 1, wherein the chip holder further comprises a location chamfer (4).

8. A chip retaining device according to claim 1, wherein the chip holder further comprises a direction mark (3).

9. A chip retaining device according to claim 1, wherein the at least one groove and the at least one sliding member have a dovetailed cross-section.

10. A chip retaining device according to claim 3, wherein the at least one location post (5) is grooved in an axial direction.

11. A chip retaining device according to claim 3, wherein each location post (5) is received in an opening provided in the chip (9).

12. A chip retaining device according to claim 4, wherein each location post (5) is received in an opening provided in the chip (9).

13. A chip retaining device according to claim 3, further comprising L-shaped undercuts on a pair edges of the protection frame (6).

14. A chip retaining device according to claim 4, further comprising L-shaped undercuts on a pair edges of the protection frame (6).

15. A chip retaining device according to claim 2, wherein the chip holder further comprises a location chamfer (4).

16. A chip retaining device according to claim 3, wherein the chip holder further comprises a location chamfer (4).

17. A chip retaining device according to claim 4, wherein the chip holder further comprises a location chamfer (4).

18. A chip retaining device according to claim 5, wherein the chip holder further comprises a location chamfer (4).

19. A chip retaining device according to claim 6, wherein the chip holder further comprises a location chamfer (4).

20. A chip retaining device according to claim 2, wherein the chip holder further comprises a direction mark (3).

21. A chip retaining device according to claim 3, wherein the chip holder further comprises a direction mark (3).

22. A chip retaining device according to claim 4, wherein the chip holder further comprises a direction mark (3).

23. A chip retaining device according to claim 5, wherein the chip holder further comprises a direction mark (3).

24. A chip retaining device according to claim 6, wherein the chip holder further comprises a direction mark (3).

25. A chip retaining device according to claim 7, wherein the chip holder further comprises a direction mark (3).

26. A chip retaining device according to claim 2, wherein the at least one groove and the at least one sliding member have a dovetailed cross-section.

27. A chip retaining device according to claim 3, wherein the at least one groove and the at least one sliding member have a dovetailed cross-section.

28. A chip retaining device according to claim 4, wherein the at least one groove and the at least one sliding member have a dovetailed cross-section.

29. A chip retaining device according to claim 5, wherein the at least one groove and the at least one sliding member have a dovetailed cross-section.

30. A chip retaining device according to claim 6, wherein the at least one groove and the at least one sliding member have a dovetailed cross-section.

31. A chip retaining device according to claim 7, wherein the at least one groove and the at least one sliding member have a dovetailed cross-section.

32. A chip retaining device according to claim 8, wherein the at least one groove and the at least one sliding member have a dovetailed cross-section.
